(19) United States
(12) Patent Application Publication
(10) Pub. No.: US 2008/0243854 A1
(43) Pub. Date: Oct. 2, 2008

(54) INFORMATION PROCESSING SYSTEM

(76) Inventor: Jumpei Noguchi, Yokohama (JP)

Correspondence Address: Mattingly Stanger and Malur PC, Ste 370, 1800 Diagonal Rd, Alexandria, VA, 22314, US

(21) Appl. No.: 11/851,732

(22) Filed: Sep. 7, 2007

(30) Foreign Application Priority Data
Mar. 27, 2007 (JP) 2007-082512

(51) Int. Cl. G06F 17/30

(52) U.S. Cl. 707/9; 707/E17.001

(57) ABSTRACT

An operated terminal monitors a connection request from an operating terminal, and when a connection request is transmitted from an operating terminal, an access right for a resource being accessed by the operated terminal is re-determined. As a result, the access right for a resource is appropriately maintained. The need for changing access environments for a resource is determined based on information that is acquired from an operating terminal that intends to access the resource, indicating location and type of the operating terminal. Software is automatically installed in an operating terminal for remote connection, and the operating terminal is automatically connected to the operated terminal.

### CROSS-REFERENCE TO RELATED APPLICATIONS

This application relates to and claims priority from Japanese Patent Application No. 2007-082512 filed on Mar. 27, 2007, the entire disclosure of which is incorporated herein by reference.

### BACKGROUND OF THE INVENTION

1. Field of the Invention

The present invention relates to an information processing system and a method and a program for controlling the information processing system.

2. Description of the Related Art

In recent years, with advancing information technologies, various pieces of information may be acquired via the Internet. For example, one may read data from or write data to a data base server or a file server connected through the Internet by transmitting a predetermined request.

On the other hand, development of various technologies is in progress for preventing leakage or falsification of confidential data and hence for improving information security. For example, a technology has been developed (e.g., Japanese Patent Application Laid-Open Publication No. 2006-92170) for restricting user operations such as reference, modification, printing, etc. of a resource such as a file by controlling access right for a resource that is assigned corresponding to a user ID and locational information of the user and by determining access right of a user accessing to the resource corresponding to user ID and locational information.

### SUMMARY OF THE INVENTION

One aspect of the present invention provides an information processing system comprising a service using terminal that accepts an operation input; a service providing server that provides a service by receiving data, that is input to the service using terminal, from the service using terminal, executing information processing in response to the input data, and transmitting a result of the execution to the service using terminal; and a data server that stores data, the service using terminal, the service providing server, and the data server being communicably connected to one another, the service using terminal including a data-input/output request transmitting unit that transmits a data-input/output request to the service providing server for data-input to or data-output from the data server, an operational environment acquiring unit that acquires information indicative of operational environments of the service using terminal, and an operational environment transmitting unit that transmits the acquired information indicative of operational environments to the service providing server, the service providing server including a data-input/output request receiving unit that receives the data-input/output request and the information indicative of operational environments from the service using terminal, and an I/O request transmitting unit that transmits the data-input/output request and the information indicative of operational environments to the data server, the data server including a data storing unit that stores data, an I/O request receiving unit that receives the data-input/output request and the information indicative of operational environments from the service providing server, data input/output control information that links operational environments of the service using terminal and information indicative of permission/disallowance to input data to or to output data from the data storing unit, a data input/output permission determining unit that determines permission or disallowance to input data to or to output data from the data storing unit by referring to the data input/output control information and based on the received information indicative of operational environments, and a data input/output processing unit that executes a process to input data to or to output data from the data storing unit in response to a result of the determination.

This configuration ensures control of data-input to and output from a data server corresponding to operational environment of a service using terminal. Hereinafter, the operational environment of a service using terminal may also be referred to as an access environment for resources. Operational environments of the service using terminal may be, for example, current location of the service using terminal, whether or not a non-volatile storage device writable for the service using terminal is provided, whether or not information for specifying an operator of the service using terminal, present time, and a channel that interconnects the service using terminal and a service providing server are encrypted, and type and specification of a program that is executed by the service using terminal, etc.

In an information processing system comprising a service using terminal that accepts operation input, a service providing server that provides a service by receiving input data from the service using terminal, executing information processing in response to the input data, and transmitting an execution result to the service using terminal, and a data server that stores data, controlled data-input to or data-output from the data server may be achieved corresponding to operational environments of a service using terminal.

### BRIEF DESCRIPTION OF THE DRAWINGS

FIG. 1 illustrates an exemplary general configuration of a remote operation system;

FIG. 2 illustrates an exemplary general configuration of a file server;

FIG. 3 illustrates an exemplary general configuration of an operated terminal;

FIG. 4 illustrates an exemplary general configuration of an operating terminal (rich client);

FIG. 5 illustrates an exemplary general configuration of an operating terminal (thin client);

FIG. 6 illustrates an exemplary access right table;

FIG. 7 illustrates an exemplary access environment change policy table;

FIG. 8 illustrates an exemplary operated terminal control table;

FIG. 9 illustrates an exemplary operating terminal control table;

FIG. 10 is a flowchart of an exemplary connection monitoring process;

FIG. 11 is a flowchart of an exemplary process when an operating terminal (rich client) directly accesses data stored in a file server;

FIG. 12 is a flowchart of an exemplary process when an operating terminal (rich client) accesses data stored on a file server via an operated terminal;

FIG. 13 is a flowchart of an exemplary access right determining process; and

FIG. 14 is a flowchart of exemplary processes by a software distribution processing unit of a file server and by a software installation processing unit of an operating terminal (rich client).

### DETAILED DESCRIPTION OF THE INVENTION

In recent years, a remote operation system has been realized, thereby a service using terminal (hereinafter, also referred to as an operating terminal), that accepts data input by a user, transmits the input data to a service providing terminal (hereinafter, also referred to as an operated terminal) communicably connected via a network, and the operated terminal executes information processing in response to the input data and indicates display information of an execution result on a display of the operating terminal.

Using the remote operation system, for example, a user may utilize various information processing services provided by a service providing server while being outside of an office by connecting a service using terminal to a service providing server set up inside of an organization via a network such as the Internet.

For example, if the service using terminal transmits a request to the service providing server for data readout from a data server, the service providing server reads out data from the data server and transmits display information indicating the data to the service using terminal.

In this case, data stored in the data server is read out by the service providing server that is set up inside the organization, but the display information of the data is displayed on the service using terminal located outside of the organization. Therefore, operational environments of the service using terminal need to be considered for preventing leakage and the like of the data.

With a conventional technology, for example, access right is controlled corresponding to a user ID and locational information of the user, but in such a case that a service using terminal uses a remote operation system for operating a service providing server that is set up in a remote place being connected by a network or that a service using terminal of a remote operation system is a thin client, access right may not be determined corresponding to environments for accessing resources, i.e., operational environments such as location and type of the service using terminal. Thus when a service using terminal such as a thin client or the like having low risk of information leakage is employed, user operation with resources is restricted and convenience is reduced.

Hence a technology is desired, that enables a service providing server to control data-input to or data-output from a data server based on operational environments of a service using terminal.

In use of an information processing system including a service using terminal that accepts operation input, a service providing server that provides services by receiving data input by the service using terminal, executing information processing in response to the input data, and transmitting an execution result to the service using terminal, and a data server that stores data, to ensure control of data-input to or data-output from the data server corresponding to operational environments of the service using terminal is one object of an embodiment of the present invention.

An embodiment is explained below based on the drawings.

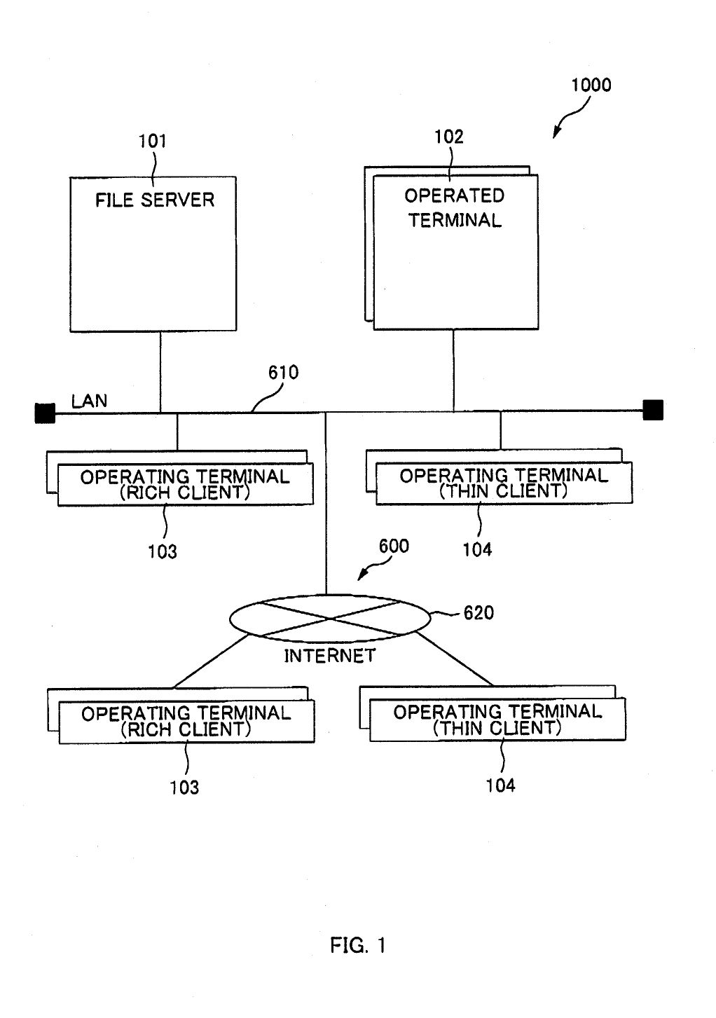

FIG. 1 illustrates an exemplary configuration of a resource control system 1000 of this embodiment.

The resource control system 1000 includes a file server 101, an operated terminal 102, and an operating terminal 103 or 104 that are communicably connected via a network 600.

The file server 101 represents a data server as claimed in claims. The operated terminal 102 represents a service providing server as claimed in claims. The operating terminal 103 or 104 represents a service using terminal as claimed in claims. The resource control system 1000 represents an information processing system as claimed in claims.

For the description to be rationalized, FIG. 1 illustrates two each of the operating terminals (rich client) 103 and the operating terminal (thin client) 104 (four in total) connected to the network 600. This is because the operating terminal (rich client) 103 connected to a LAN 610, the operating terminal (thin client) 104 connected to a LAN 610, the operating terminal (rich client) 103 connected to the Internet 620, and the operating terminal (thin client) 104 connected to the Internet 620 are collectively illustrated. At least one of either the operating terminals (rich client) 103 or the operating terminal (thin client) 104 may be connected to the LAN 610 or the Internet 620.

The operating terminals 103 and 104 may be configured by, e.g., a laptop computer, a mobile phone, a computer such as a PDA (Personal Digital Assistants), etc.

The operating terminals 103 and 104 are computers that may communicate with the operated terminal 102 by connecting to the network 600 (hereinafter, also referred to as remote connection) from various locations such as a business trip destination, home, or anyplace during traveling of a user. The operating terminals 103 and 104 accept data input by a user and transmit the input data to the operated terminal 102. The operating terminals 103 and 104 then receive and display display data indicating an execution result of information processing executed by the operated terminal 102 in response to the input data.

The operating terminal (rich client) 103 is a computer provided with a data writable non-volatile storage device. A storage device is a device provided with a non-volatile recording medium such as a hard disc or a flash memory.

The operating terminal (thin client) 104 is a computer without a data writable non-volatile storage device. Therefore, the operating terminal (thin client) 104 may input and display data, but may not store data.

The operated terminal 102 is a computer that provides services by receiving data input by the operating terminal 103 or 104, executing information processing in response to the input data, and transmitting an execution result to the operating terminal 103 or 104.

The operated terminal 102 may be configured by, e.g., an individual blade computer that makes up a blade server. The blade computer is an integrally formed circuit board that functions as a computer, and a blade server is configured by installing a plurality of blade computers of the same specification in a housing. The operated terminal 102 may also be made up with a computer such as a personal computer, a work station, or a main frame.

A plurality of operated terminals 102 may be connected to the LAN 610. In this case, for example, each operated terminal 102 may be set up in a same building, or may be set up in separate locations, e.g., one part is set up in Tokyo and rest part is set up in Osaka.

The file server 101 is a computer storing various data, and executes data input/output processing in response to a data-input/output request transmitted from other computers such as the operated terminal 102.

In the resource control system 1000 of this embodiment, if the operating terminal 103 or 104 transmits data-input/output request to the operated terminal 102 to input data to or to output data from the file server 101, the operated terminal 102 transmits the data-input/output request to the file server 101. The file server 101 executes data input/output processing in response to the data-input/output request, and transmits an execution result to the operated terminal 102. The operated terminal 102 generates display data indicating the execution result, and transmits to the operating terminal 103 or 104.

Thus, for example, if the operating terminal 103 or 104 transmits a request to the operated terminal 102 for readout of data stored on the file server 101, the operated terminal 102 transmits display data indicating contents of the data to the operating terminal 103 or 104. Hence a user of the operating terminal 103 or 104 may view the data.

In the case that the operating terminal (thin client) 104 transmits a data readout request to the operated terminal 102, contents of the data is not stored in the operating terminal (thin client) 104 as the operating terminal (thin client) 104 does not have a data writable non-volatile storage device. Therefore, risk of leakage of data read out from the file server 101 is low in this case.

On the other hand, in the case that the operating terminal (rich client) 103 transmits a data readout request to the operated terminal 102, contents of the data may be stored in the operating terminal (rich client) 103 as the operating terminal (rich client) 103 has a data writable non-volatile storage device. Therefore, if the operating terminal (rich client) 103 is stolen, data read out from the file server 101 may leak out to a third party.

No matter which of the operating terminal (thin client) 104 or the operating terminal (rich client) 103 may transmits a data readout request to the operated terminal 102, risk that data read out from the file server 101 leaks out of a company is low provided that the operating terminal 103 or 104 is connected to an in-company LAN 610.

Thus risk of leakage of data readout from the file server 101 to outside largely depends upon operational environments of the operating terminal 103 or 104 such as current location of the operating terminal 103 or 104 and equipment status of a hard disc drive.

Similar situation is expected also in the case of writing data to the file server 101. For example, when a location of the operating terminal 103 or 104 is outside of a company, there is a possibility that a person who stole the operating terminal 103 or 104 intends to falsify data stored on the file server 101. In the case that a location of the operating terminal 103 or 104 is inside of a company, however, possibility of data falsification is low since possibility that third party operates the operating terminal 103 or 104 is low.

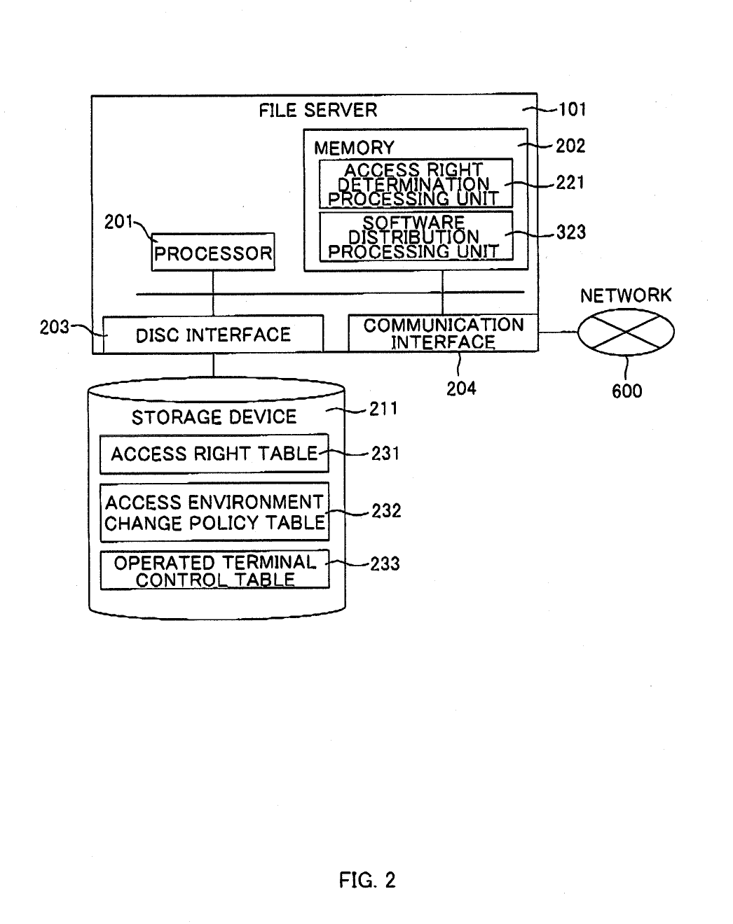

FIG. 2 illustrates exemplary program and hardware configuration of the file server 101.

The hardware configuration of the file server 101 is explained. The file server 101 includes a processor 201, a memory 202, and a storage device 211.

The file server 101 is connected to the network 600 such as the LAN 610 via a communication interface 204. The file server 101 accesses data such as various files and tables (hereinafter, also referred to as resources) stored on the storage device 211 such as a hard disc drive via a disc interface 203.

A program configuration of the file server is explained.

The file server 101 includes an access right determination processing unit 221 and a software distribution processing unit 323. The storage device 211 contains an access right table 231, an access environment change policy table 232, and an operated terminal control table 233.

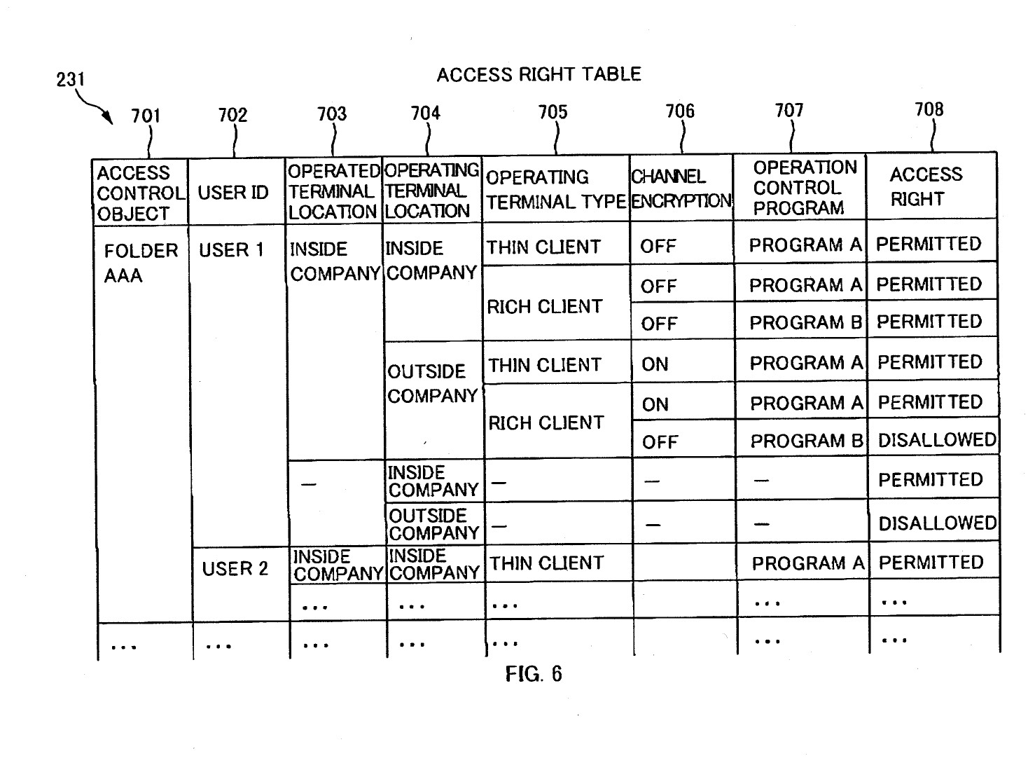

The access right table 231 stores data input/output control information that contains operational environments of the operating terminal 103 or 104 linked with information indicating permission or disallowance to input data to or to output data from the storage device 211. The file server 101 determines permission or disallowance to input data to or to output data from the storage device 211 corresponding to operational environments such as current location and type of the operating terminal 103 or 104 that sent a data-input/output request via the operated terminal 102, and executes data input/output processing depending upon a determined result. Details are described later. Type of the operating terminal 103 or 104 may be categorized by, e.g., whether or not the operating terminal 103 or 104 contains a writable non-volatile storage device. An exemplary access right table 231 is shown in FIG. 6.

The access right table 231 stores data input/output control information that contains following linked information: access control object 701 indicating a resource to be an access control object: user ID 702 indicating a user ID of an access control object; operated terminal location 703 indicating a location of the operated terminal 102 that accesses a resource; operating terminal location 704 indicating a location of the operating terminal (rich client) 103 or the operating terminal (thin client) 104; operating terminal type 705 indicating a type of an operating terminal, i.e., a rich client or a thin client; channel encryption 706 indicating an encryption state of a communication channel for remote connection; operation control program 707 indicating a program to be executed by the operating terminal 103 or 104 for remote connection to the operated terminal 102; and access right 708 indicating right for accessing a resource assigned in the access control object 701.

Contents of each column of the access right table 231 may be assigned by an author of a resource or by an administrator of the file server 101. The access right determination processing unit 221 of the file server 101 determines access right 708, that is a right for accessing a resource, using values of individual columns of access control object 701, user ID 702, operated terminal location 703, operating terminal location 704, operating terminal type 705, channel encryption 706, and operation control program 707 as determination criteria. Details of a process executed by the access right determination processing unit 221 are described later.

The access environment change policy table 232 stores information on a condition and contents to be changed for changing operational environments of the operating terminal 103 or 104 that transmits a data-input/output request via the operated terminal 102. For example, of various programs executed by the operating terminal 103 or 104 for remote connection between the operating terminal 103 or 104 and the operated terminal 102, storing identification information of programs, that are not recommended for security reasons, in the access environment change policy table 232 as the condition, and thereby if an identification information of a program being executed by the operating terminal 103 or 104 for remote connection to the operated terminal 102 is found to be identical with the identification information stored in the access environment change policy table 232 as a program that is not recommended when the operating terminal 103 or 104 transmits a data-input/output request to the file server 101 via the operated terminal 102, the file server 101 transmits, e.g., a recommended program pre-installed on the storage device 211 to the operating terminal 103 or 104.

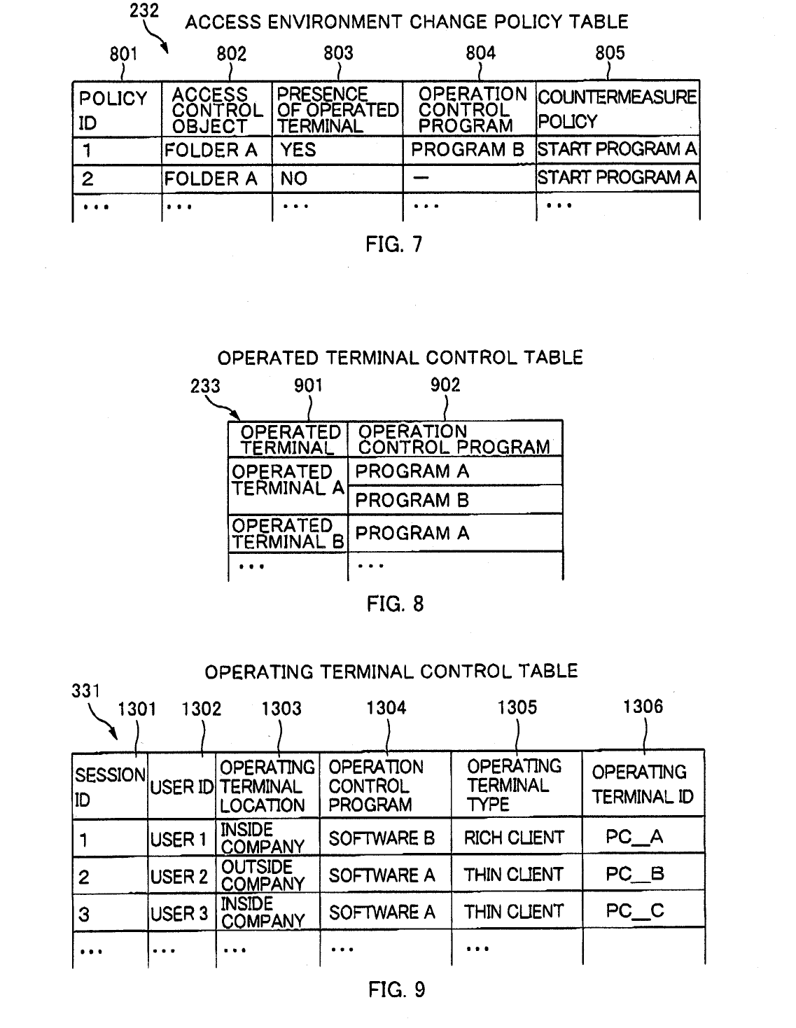

This configuration ensures maintenance of appropriate operational environments of the operating terminal 103 or 104. For example, security of data stored in the file server 101 may be improved by compulsorily transmitting and installing a recommended program to the operating terminal 103 or 104, that is executing a program that is not proved for security for data leakage, to change the operational environments of the operating terminal 103 or 104. An exemplary access environment change policy table 232 is shown in FIG. 7.

The access environment change policy table 232 includes individual columns of policy ID 801 indicating identification numbers of policy, access control object 802 indicating object resources for access control, presence of operated terminal 803 indicating use or nonuse of remote connection, operation control program 804 indicating a program being executed by the operating terminal 103 or 104 for remote connection to the operated terminal 102, and countermeasure policy 805 indicating countermeasure policies defined for changing environment to access resources. For an exemplary case of policy number 1 of FIG. 7, a program B in the operation control program column is a program that is not recommended.

The access right determination processing unit 221 of the file server 101 determines a need for changing access environments for a resource by using values in each column of access control object 802, presence of operated terminal 803, and operation control program 804 as conditions for changing access environments. In the case that an access environment is changed, the operated terminal 102 is requested for execution of a process defined in the column of countermeasure policy 805.

The operated terminal control table 233 contains identification information of, among various programs executed by the operating terminal 103 or 104 for remote connection to the operated terminal 102, programs to which individual operated terminals 102 are adaptive. An exemplary operated terminal control table 233 is shown in FIG. 8.

The operated terminal control table 233 includes columns of operated terminal 901 that indicates ID of the operated terminals 102 such as host names and operation control program 902 indicating programs applicable for remote connection to the operated terminals 102.

Contents of each column of operated terminal 901 and operation control program 902 are assigned by an administrator of the file server 101 or the operated terminal 102, or the like.

The access right determination processing unit 221 determines permission or disallowance to input data to or to output data from the storage device 211 based on information indicative of operational environments of the operating terminal 103 or 104 referring to the access right table 231. The access right determination processing unit 221 executes data-input to or output from the storage device 211 in response to a result of the determination.

The access right determination processing unit 221 identifies the operated terminal 102 that supports a program defined in countermeasure policy 805 of the access environment change policy table 232 referring to the operated terminal control table 233 before requesting the operated terminal 102 for change of an access environment for a resource, and requests the operated terminal 102 identified for distribution and starting of software.

The software distribution processing unit 323 reads out a recommended program, that is described in a countermeasure policy column of the access environment change policy table 232, from the storage device 211 and transmits to the operating terminal 103 or 104 in case identification information of a program being executed by the operating terminal 103 or 104 for remote connection to the operated terminal 102 is found to be identical with identification information stored in the access environment change policy table 232 as a program that is not recommended.

The access right determination processing unit 221 represents a data input/output permission determining unit and a data input/output processing unit as claimed in claims. The software distribution processing unit 323 represents a recommended program transmitting unit as claimed in claims. The access right table 231 represents a data input/output control table as claimed in claims. The storage device 211 represents a data storing unit and a recommended program storing unit as claimed in claims. The communication interface 204 represents an I/O request receiving unit and a read-out data transmitting unit as claimed in claims.

These individual processing units are materialized by the processor 201 executing various programs (not shown). These individual processing units are also materialized by hardware such as an integrated circuit.

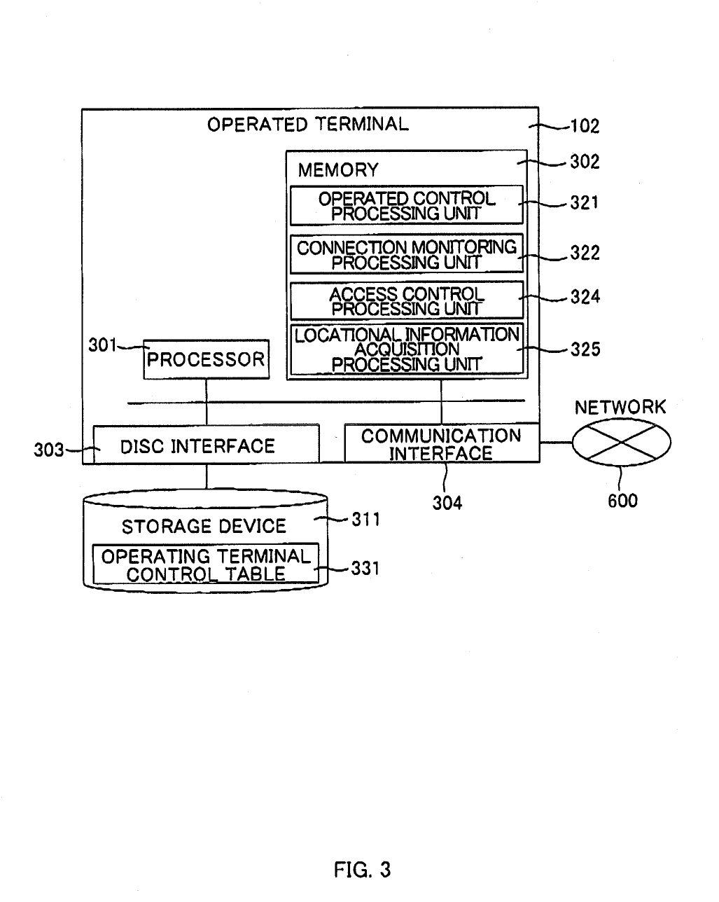

FIG. 3 illustrates an exemplary configuration of programs and hardware of the operated terminal 102.

Hardware configuration of the operated terminal 102 is explained.

The operated terminal 102 includes a processor 301, a memory 302, and a storage device 311. The operated terminal 102 is connected to the network 600 such as the LAN 610 through a communication interface 304. The operated terminal 102 accesses various data and tables stored on the storage device 311 such as a hard disc drive through a disc interface 303.

A program configuration of the operated terminal 102 is explained.

The operated terminal 102 includes an operated control processing unit 321, a connection monitoring processing unit 322, an access control processing unit 324, and a locational information acquisition processing unit 325. An operating terminal control table 331 is stored on the storage device 311.

The operating terminal control table 331 controls various information such as identification information of the operating terminal 103 or 104 that is remote-connecting to the operated terminal 102. An exemplary operating terminal control table 331 is shown in FIG. 9.

The operating terminal control table 331 contains session ID 1301 indicating ID of display information for transmitting to the operating terminal (rich client) 103 and the operating terminal (thin client) 104, user ID 1302 that is identification information of a user using the operating terminal (rich client) 103 and the operating terminal (thin client) 104, location 1303 that is locational information of the operating terminal (rich client) 103 and the operating terminal (thin client) 104 connected to the operated terminal 102, operation control program 1304 that is executed for remote connection, operating terminal type 1305 indicating type of the operating terminal (rich client) 103 and the operating terminal (thin client) 104, and operating terminal ID 1306 that is a terminal ID such as host name of the operating terminal (rich client) 103 and the operating terminal (thin client) 104 connected to the operated terminal 102.

Session ID 1301 is issued by the connection monitoring processing unit 322 and used by the connection monitoring processing unit 322 for counting the number of access to the same display information. User ID 1302, operating terminal location 1303, operation control program 1304, operating terminal type 1305, and operating terminal ID 1306 are used by the access control processing unit 324 or the like for determining access right for resources on the file server 101.

The operated control processing unit 321 provides a service by receiving data, that is input to the operating terminal 103 or 104, from the operating terminal 103 or 104, executing information processing in response to the input data, and transmitting an execution result to the operating terminal 103 or 104.

The connection monitoring processing unit 322 executes a process related to remote connection to the operating terminal 103 or 104. In other words, when a request for remote connection to the operated terminal 102 is transmitted from the operating terminal 103 or 104, the connection monitoring processing unit 322 executes predetermined login process and establishes remote connection between the operating terminal 103 or 104 and the operated terminal 102. The operating terminal 103 or 104 is then notified of completion of the remote connection. Details are described later.

The access control processing unit 324 transmits a data-input/output request, that is transmitted from the operating terminal 103 or 104 to the operated terminal 102, to the file server 101 and executes a readout or writing process of data.

The locational information acquisition processing unit 325 acquires information indicating current location of the operated terminal 102 as information indicating an operational environment of the operated terminal 102. The locational information acquisition processing unit 325 is configured including, e.g., a GPS (Global Positioning System) receiver. The locational information acquisition processing unit 325 acquires information indicating latitude and longitude of the operated terminal 102 as information indicating current location of the operated terminal 102. Information indicating altitude may also be acquired. The locational information acquisition processing unit 325 may acquire a network address of the operated terminal 102 as information indicating current location of the operated terminal 102.

The operated control processing unit 321 represents a display information generating unit as claimed in claims. The locational information acquisition processing unit 325 represents a second operational environment acquiring unit as claimed in claims. The communication interface 304 represents a data-input/output request receiving unit, an I/O request transmitting unit, a data receiving unit, and a display information transmitting unit as claimed in claims.

These individual processing units are materialized by the processor 301 executing various programs (not shown). These individual processing units are also materialized by hardware such as an integrated circuit.

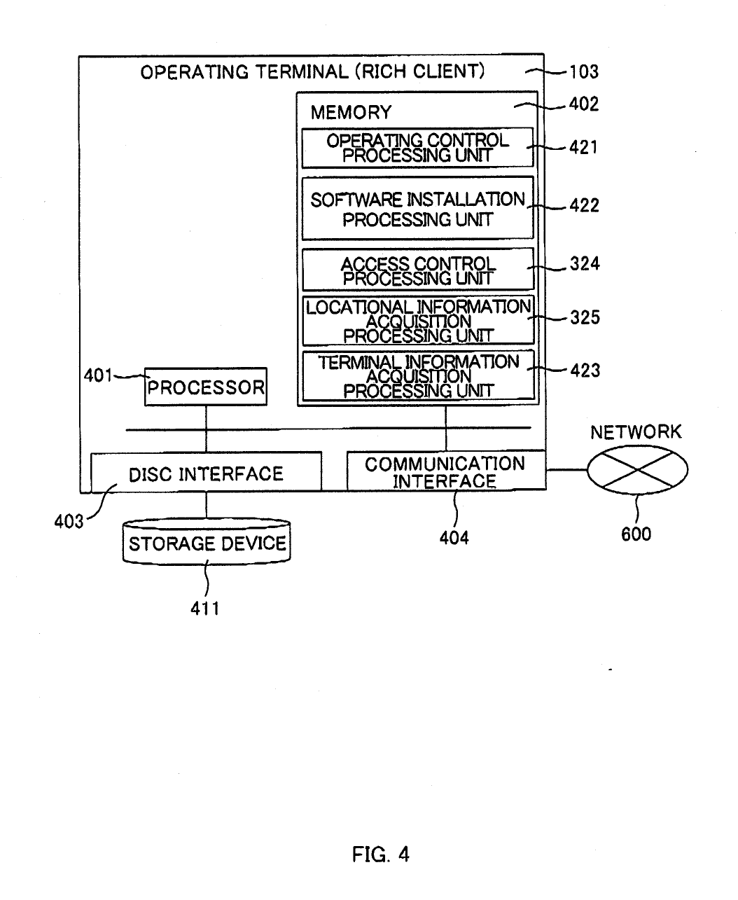

FIG. 4 illustrates an exemplary configurations of programs and hardware of the operating terminal (rich client) 103.

A hardware configuration of the operating terminal (rich client) 103 is explained. The operating terminal (rich client) 103 includes a processor 401, a memory 402, and a storage device 411. The operating terminal (rich client) 103 is connected via a communication interface 404 to a network 600 such as a LAN 610, the Internet 620 and the like. The operating terminal (rich client) 103 may access via a disc interface 403 the storage device 411 such as a hard disc drive.

A program configuration of the operating terminal (rich client) 103 is explained. The operating terminal (rich client) 103 includes an operation control processing unit 421, a software installation processing unit 422, an access control processing unit 324, a locational information acquisition processing unit 325, and a terminal information acquisition processing unit 423.

The operation control processing unit 421 executes a program for using a service provided by the operated terminal 102 (hereinafter, also referred to as service using program) for remote connection to the operating terminal (rich client) 103. Thereby the operating terminal (rich client) 103 accepts is operation input by a user and displays display information, that indicates an execution result of information processing executed by the operated terminal 102 in response to the input data, on a display device such as a display monitor.

When a new service using program is acquired from the file server 101, the software installation processing unit 422 executes a process for updating a service using program, that is presently executed, to the new service using program.

The access control processing unit 324 transmits data-input/output request to the file server 101 and thereby executes a readout or writing process of data.

The locational information acquisition processing unit 325 acquires information indicating current location of the operating terminal (rich client) 103 as information indicating an operational environment of the operating terminal (rich client) 103. The locational information acquisition processing unit 325 is configured including, e.g., a GPS receiver, and acquires information indicating latitude and longitude of the operating terminal (rich client) 103 as information indicating current location of the operating terminal (rich client) 103. Information indicating altitude may also be acquired. The locational information acquisition processing unit 325 may acquire a network address of the operating terminal (rich client) 103 as information indicating current location of the operating terminal (rich client) 103.

The terminal information acquisition processing unit 423 acquires information related to a storage device 411 from device information or the like as information indicating an operational environment of the operating terminal (rich client) 103. The terminal information acquisition processing unit 423 acquires terminal information by determining that the operating terminal is a rich client if a writable non-volatile storage device 411 is present or a thin client if a writable non-volatile storage device 411 is absent.

The operation control processing unit 421 of the operating terminal (rich client) 103 and the operated control processing unit 321 of the operated terminal 102 are for operating the operated terminal 102, that is located in a remote place and connected to the network 600, from the operating terminal (rich client) 103. The operation control processing unit 421 controls and transmits input from a keyboard or a mouse of the operating terminal (rich client) 103, and displays display information received on a display monitor. The operated control processing unit 321 executes a process when receiving input by a keyboard or a mouse from the operation control processing unit 421 and transmits display information to the operating terminal (rich client) 103. The operation control processing unit 421 and the operated control processing unit 321 have a function for a user to login to the operated terminal 102 from the operating terminal (rich client) 103.

The operation control processing unit 421 represents a program executing unit as claimed in claims. The locational information acquisition processing unit 325 and the terminal information acquisition processing unit 423 represent an operational environment acquiring unit as claimed in claims. The software installation processing unit 422 represents a program updating unit as claimed in claims. The communication interface 404 represents a data-input/output request transmitting unit, an operational environment transmitting unit, a program information transmitting unit, and a recommended program receiving unit as claimed in claims.

These individual processing units are materialized by the processor 401 executing various programs (not shown). These individual processing units are also materialized by hardware such as an integrated circuit.

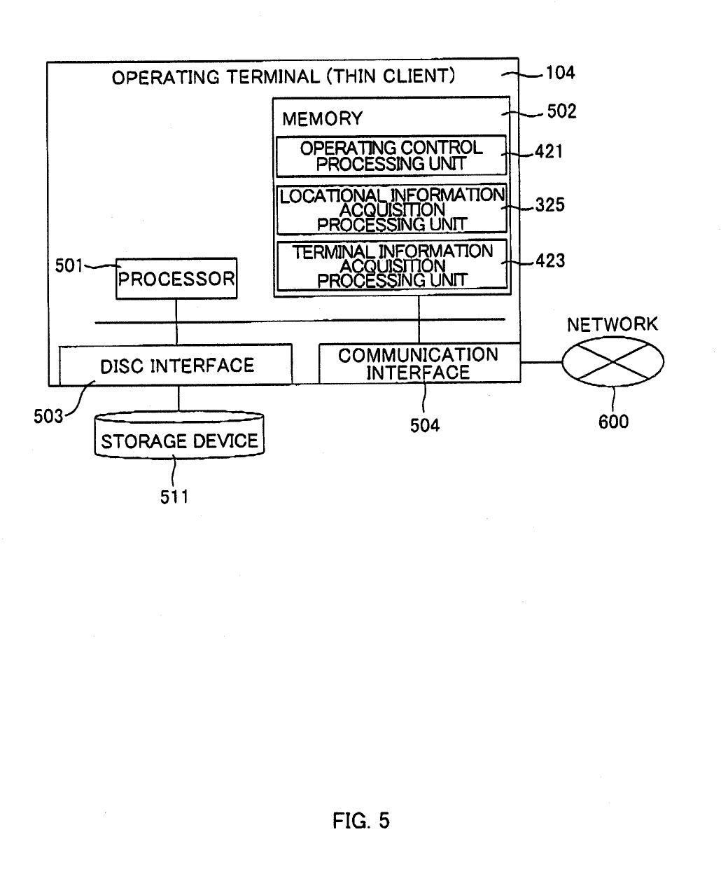

FIG. 5 illustrates an exemplary configuration of programs and hardware of the operating terminal (thin client) 104.

A hardware configuration of the operating terminal (thin client) 104 is explained. The operating terminal (thin client) 104 has a processor 501, a memory 502, and a storage device 511. The operating terminal (thin client) 104 is connected to a network such as a LAN or the Internet via a communication interface 504. The operating terminal (thin client) 104 accesses the storage device such as a hard disc drive or the like via a disc interface 503.

The storage device 511 of the operating terminal (thin client) 104 is readable but not writable. The storage device 511 stores various programs for implementing each function of the operating terminal (thin client) 104 described below, and these programs are read out to the memory 502 and executed by the processor 501.

A program configuration of the operating terminal (thin client) 104 is explained. The operating terminal (thin client) 104 has an operation control processing unit 421, a locational information acquisition processing unit 325, and a terminal information acquisition processing unit 423.

The operation control processing unit 421 executes a service using program for utilizing a service provided by the operated terminal 102 for remote connection to the operating terminal (thin client) 104. Thereby the operating terminal (thin client) 104 accepts operation input by a user and displays display information, that indicates an execution result of information processing executed by the operated terminal 102 in response to the input data, on a display device such as a display monitor.

The locational information acquisition processing unit 325 acquires information indicating current location of the operating terminal (thin client) 104 as information indicating an operational environment of the operating terminal (thin client) 104. The locational information acquisition processing unit 325 is configured including, e.g., a GPS receiver, and acquires information indicating latitude and longitude of the operating terminal (thin client) 104 as information indicating current location of the operating terminal (thin client) 104. Information indicating altitude may also be acquired. The locational information acquisition processing unit 325 may acquire a network address of the operating terminal (thin client) 104 as information indicating current location of the operating terminal (thin client) 104.

The terminal information acquisition processing unit 423 acquires information related to a storage device 511 from device information or the like as information indicating an operational environment of the operating terminal (thin client) 104. The terminal information acquisition processing unit 423 acquires terminal information by determining that the operating terminal is a rich client if a writable non-volatile storage device 511 is present or a thin client if a writable non-volatile storage device 511 is absent.

The operation control processing unit 421 of the operating terminal (thin client) 104 and the operated control processing unit 321 of the operated terminal 102 are for operating the operated terminal 102, that is located in a remote place and connected to the network 600, from the operating terminal (thin client) 104. The operation control processing unit 421 controls and transmits input from a keyboard or a mouse of the operating terminal (thin client) 104, and displays display information received on a display monitor. The operated control processing unit 321 executes a process when receiving input by a keyboard or a mouse from the operation control processing unit 421 and transmits display information to the operating terminal (thin client) 104. The operation control processing unit 421 and the operated control processing unit 321 have a function to login to the operated terminal 102 from the operating terminal (thin client) 104.

The operation control processing unit 421 represents a program executing unit as claimed in claims. The locational information acquisition processing unit 325 and the terminal information acquisition processing unit 423 represent an operational environment acquiring unit as claimed in claims. The communication interface 504 represents a data-input/output request transmitting unit, an operational environment transmitting unit, a program information transmitting unit, and a recommended program receiving unit as claimed in claims.

These individual processing units are materialized by the processor 501 executing various programs (not shown). These individual processing units are also materialized by hardware such as an integrated circuit.

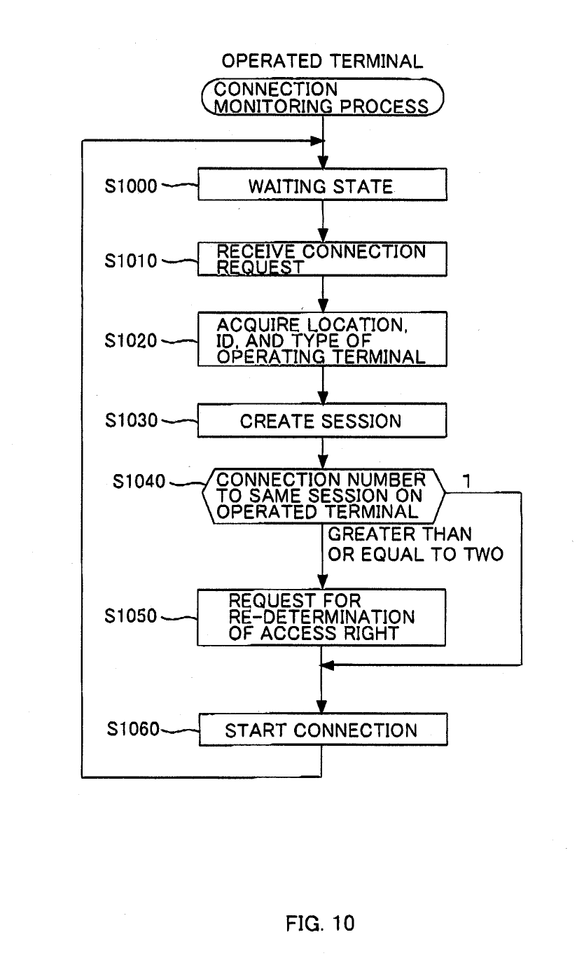

FIG. 10 is a flowchart of an exemplary process of the connection monitoring processing unit 322 of the operated terminal 102.

The connection monitoring processing unit 322 waits in standby state (S1000) until reception of a connection request from the operating terminal (rich client) 103 or the operating terminal (thin client) 104. The connection request is a request for the operating terminal 103 or 104 to receive a remote connection service from the operated terminal 102.

On reception of a connection request (S1010), the connection monitoring processing unit 322 receives information related to access environments of the operating terminal (rich client) 103 or the operating terminal (thin client) 104 such as locational information, a user ID, name of a program used for remote connection, type of a terminal, and a terminal ID such as host name from the operating terminal (rich client) 103 or the operating terminal (thin client) 104 (S1020).

The connection monitoring processing unit 322 assigns a session ID based on the user ID received, and generates a session (S1030). The connection monitoring processing unit 322 records information related to the access environments and the session ID to the operation terminal control table 331 of FIG. 9. The session ID is an ID indicating display information assigned when the operating terminal (rich client) 103 or the operating terminal (thin client) 104 is remote-connected to the operated terminal 102.

The connection monitoring processing unit 322 counts the number of session ID 1301, that are components of the operating terminal control table 331, having a value equal to the session ID acquired at S1030 (S1040).

If the number of session counted at S1040 is one, display information of the operated terminal 102 is exclusively utilized by the operating terminal (rich client) 103 or the operating terminal (thin client) 104 that transmitted connection request at S1010. In this case, the connection monitoring processing unit 322 starts to share display information between the operated terminal 102 and the operating terminal (rich client) 103 or the operating terminal (thin client) 104.

On the other hand, if the number of the same session ID is two or more, a plurality of operating terminals (rich clients) 103 and the operating terminals (thin clients) 104 share the same display information.

In this case, if one of the operating terminals 103 or 104 sharing display information transmits a data readout request to the file server 101, display information indicating data read out from the file server 101 is transmitted respectively to other operating terminals 103 or 104.

Therefore, the connection monitoring processing unit 322 refers to environmental information acquired at S1020 and to information contained in the operating terminal control table 331 and requests the access right determination processing unit 221 for re-determination of access right for resources on the file server 101 (S1050).

In response to this, the file server 101 determines access right for each operating terminal 103 or 104 based on environmental information of each operating terminal 103 or 104 sharing display information. If anyone result of disallowance is given, access such as readout or writing of data is not executed. This ensures securer prevention of leakage of data stored on the file server 101. Details of access right determination process are described later.

The connection monitoring processing unit 322 starts connection to the operating terminals (rich clients) 103 or the operating terminals (thin clients) 104 (S1060) that requests for connection after acquiring access right for resources, and starts sharing of display information between the operated terminal 102 and the operating terminals (rich clients) 103 or the operating terminals (thin clients) 104.

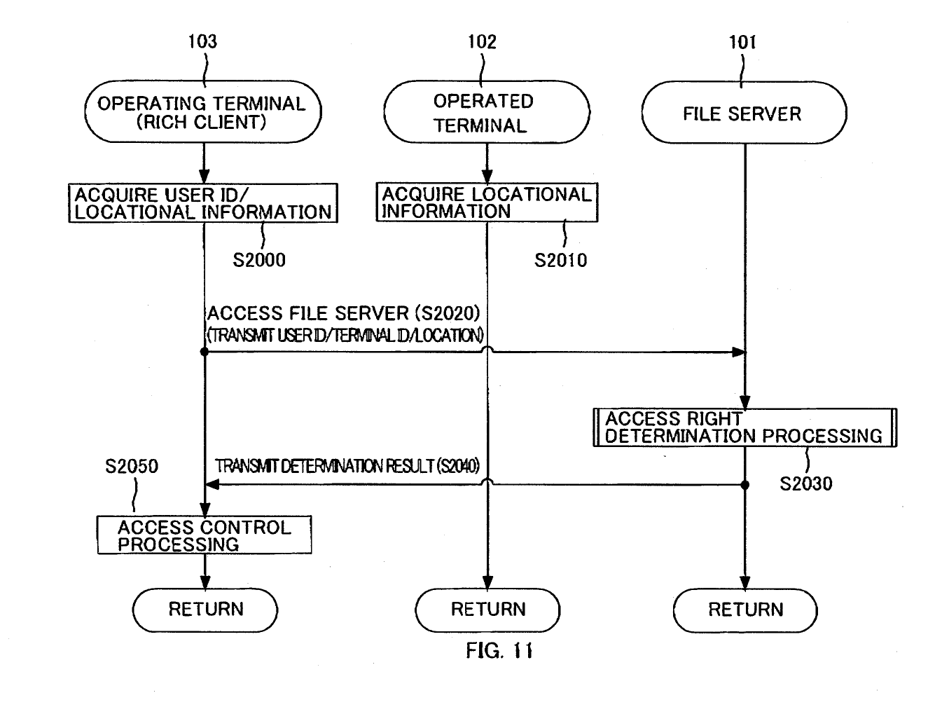

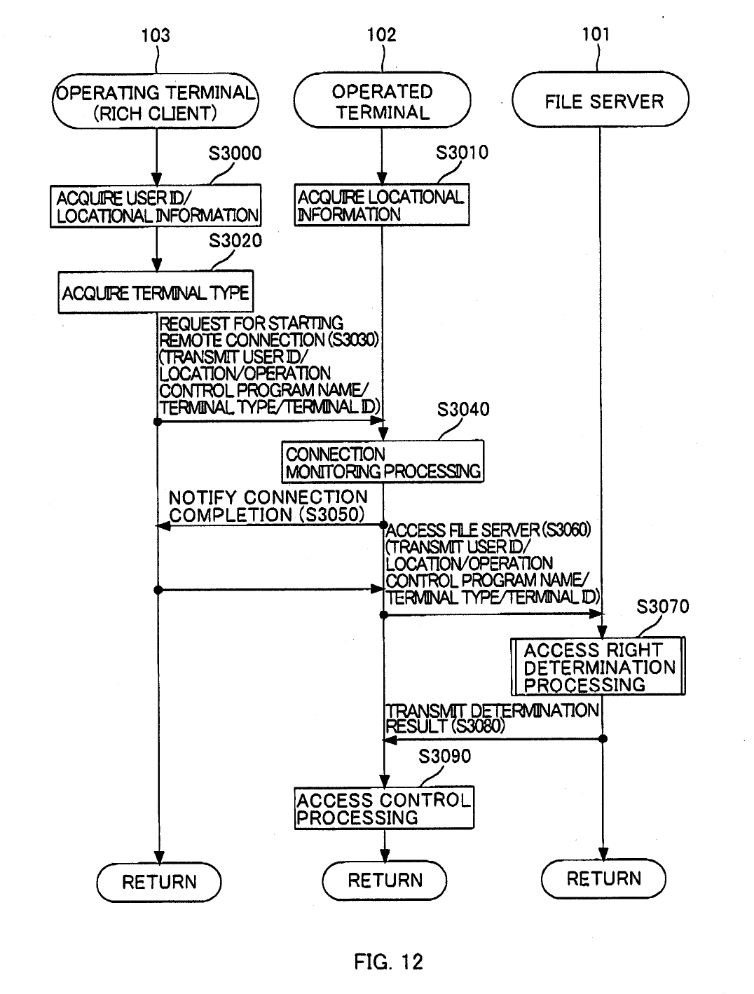

FIGS. 11 and 12 are flowcharts of exemplary flows of a process when the operating terminal (rich client) 103 accesses data stored on the file server 101 and a process for determining access right for resources, respectively.

The operating terminal (rich client) 103 may access directly to the file server 101 (hereinafter, also referred to as a file server access 1), or may remote-connect to the operated terminal 102 and then accesses the file server 101 via the operated terminal 102 (hereinafter, also referred to as a file server access 2).

FIG. 11 is a flowchart of the case that the operating terminal (rich client) 103 accesses directly to data stored on the file server 101. FIG. 12 is a flowchart of the case that the operating terminal (rich client) 103 accesses data stored on the file server 101 via the operated terminal 102.

Since the operating terminal (thin client) 104 accesses the file server 101 via the operated terminal 102 after remote-connecting to the operated terminal 102 (not shown), access control for resources is executed by the same processing flow as the file server access 2.

The file server 101 access 1 is explained referring to FIG. 11. The operating terminal (rich client) 103 computes locational information such as latitude and longitude based on data received from a GPS. The operating terminal (rich client) 103 acquires a user ID from, e.g., a user ID to logon to an OS (Operating System) (S2000).

The operating terminal (rich client) 103 saves the locational information and the user ID acquired in the memory 402 or the like of the operating terminal (rich client) 103. The locational information acquisition processing unit 325 executes acquisition of locational information, and the locational information may be computed using either a GPS or an IP address.

On the other hand, the operated terminal 102 computes locational information such as latitude and longitude based on data received from a GPS (S2010) and saves in the memory 302 or the like. The locational information acquisition processing unit 325 executes acquisition of locational information, and the locational information may be computed using either a GPS or an IP address.

The processes of S2000 and S2010 are executed at startup of the operating terminal (rich client) 103 and the operated terminal 102, and locational information may be acquired at regular intervals.

The operating terminal (rich client) 103 transmits the user ID and locational information acquired at S2000, and host name as a terminal ID of the operating terminal (rich client) 103 to the file server 101 (S2020) when transmitting a data-input/output request to the file server 101.

The access right determination processing unit 221 of the file server 101 determines access right for resources (S2030) based on the data received making reference to predetermined values of the access right table 231. The file server 101 transmits a result of the determination to the operating terminal (rich client) 103 (S2040).

The access control processing unit 324 of the operating terminal (rich client) 103 controls access for resources by following access right received. In other words, if access for resources is permitted, the file server 101 executes a data input/output process in response to a data-input/output request transmitted from the operating terminal (rich client) 103. If access for resources is disallowed, the data input/output process is not executed.

The file server access 2 is explained referring to FIG. 12. The operating terminal (rich client) 103 computes locational information such as latitude and longitude based on data received from a GPS. The operating terminal (rich client) 103 acquires a user ID from, e.g., a user ID to logon to an OS (S3000).

The operating terminal (rich client) 103 saves the locational information and the user ID acquired in the memory 402 or the like of the operating terminal (rich client) 103. The locational information acquisition processing unit 325 executes acquisition of locational information, and the locational information may be computed using either a GPS or an IP address.

On the other hand, the operated terminal 102 computes locational information such as latitude and longitude based on data received from a GPS (S3010) and saves on the memory 302 or the like. The locational information acquisition processing unit 325 executes acquisition of locational information, and the locational information may be computed using either a GPS or an IP address.

The processes of S3000 and S3010 are executed at startup of the operating terminal (rich client) 103 and the operated terminal 102, and locational information may be acquired at regular intervals.

The operating terminal (rich client) 103 acquires terminal type information from device information or the like (S3020). The terminal type information is information related to, e.g., a storage device, and terminal type information is given through determination that the operating terminal is a rich client if a writable non-volatile storage device is present or a thin client if a writable non-volatile storage device is absent.

S3020 is executed at, e.g., startup of a program for remote connection. Acquisition of terminal type information is executed by the terminal information acquisition processing unit 423.

The operating terminal (rich client) 103 requests the operated terminal 102 for start of remote connection (S3030). At this time, the operating terminal (rich client) 103 transmits the user ID and locational information acquired at S3000, the terminal type information acquired at S3020, name of operation control program used for remote connection, and a terminal ID such as host name to the operated terminal 102.

The connection monitoring processing unit 322 of the operated terminal 102 executes a connection monitoring process (S3040). More specifically, the operated terminal 102 establishes a connection between the operating terminal (rich client) 103 and the operated terminal 102 on reception of a user ID, locational information, terminal type, operation control program name, and a terminal ID from the operating terminal (rich client) 103. Then the operated terminal 102 notifies the operating terminal (rich client) 103 of completion of the connection (S3050).

When the operating terminal (rich client) 103 connected to the operated terminal 102 requests the file server 101 for data access, the operated terminal 102 executes actual access to the file server 101.

At this time, the operated terminal 102 transmits the locational information of the operated terminal 102 acquired at S3010, a user ID, locational information of the operating terminal (rich client) 103, terminal type, name of operation control program used for remote connection, and a terminal ID that are received from the operating terminal (rich client) 103 at S3030 to the file server 101.

The access right determination processing unit 221 of the file server 101 determines access right for resources (S3070) based on the data received making reference to predetermined values of the access right table 231. The file server 101 transmits a result of the determination to the operated terminal 102 (S3080).

The access control processing unit 324 of the operated terminal 102 controls access for resources by following access right received. In other words, if access for resources is permitted, the file server 101 executes a data input/output process in response to a data-input/output request transmitted from the operating terminal (rich client) 103. If access for resources is disallowed, the data input/output process is not executed.

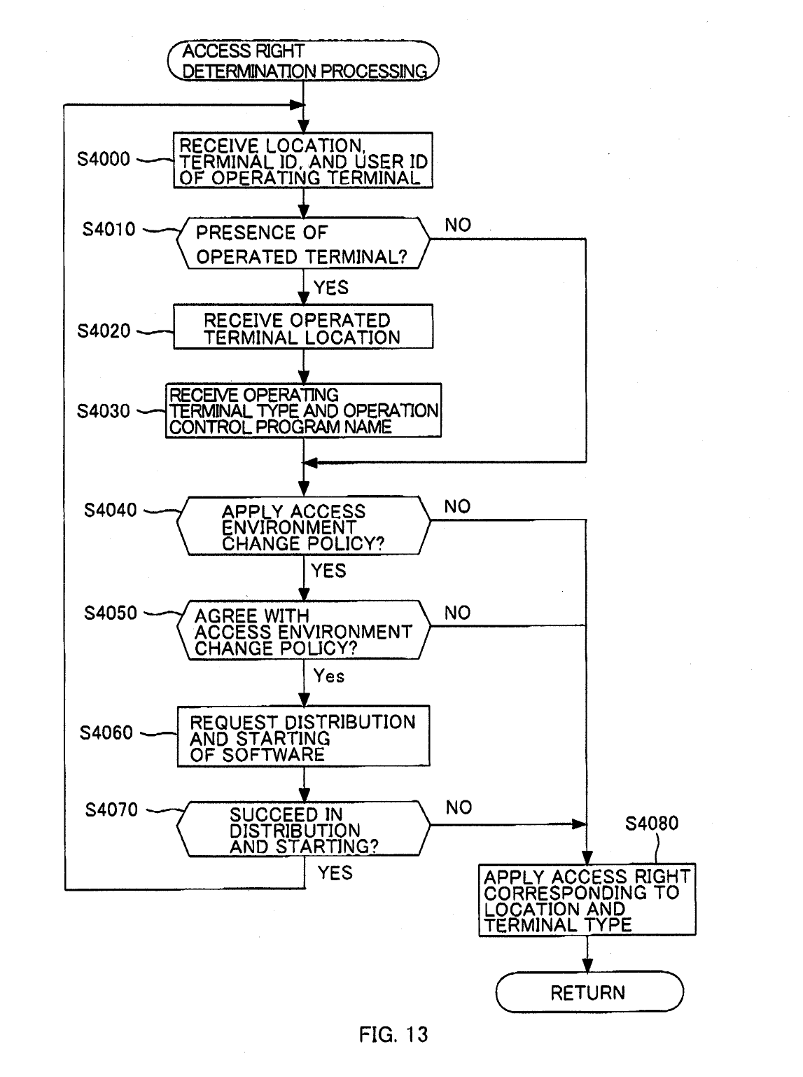

FIG. 13 is a flowchart of an exemplary process of the access right determination processing unit 221 of the file server 101.

The access right determination processing unit 221 receives locational information, a terminal ID, and a user ID of an operation terminal that are transmitted from the operating terminal (rich client) 103 or the operated terminal 102 (S4000).

In the case that the operating terminal 103 or 104 accesses resources on the file server 101 via the operated terminal 102 by remote connection, since locational information, etc of the operated terminal 102 are also transmitted to the access right determination processing unit 221, the access right determination processing unit 221 determines presence or absence of an operated terminal based on whether or not data received includes locational information of the operated terminal 102 (S4010).

In the case that the operating terminal 103 or 104 accesses resources on the file server 101 via the operated terminal 102 (S4010-yes), locational information of the operated terminal 102 is received (S4020), and type of operation terminal connected to the operated terminal 102 and identification information of a program used for remote connection (service using program) are received (S4030).

On the other hand, in the case that the operating terminal (rich client) 103 directly accesses resources on the file server 101 (S4010-no), steps such as reception of locational information of the operated terminal 102 are skipped.

The access right determination processing unit 221 determines whether or not access environment change policy is applied (S4040) referring to a flag indicating whether or not application of access environment change policy is necessary. The flag indicating whether or not application of access environment change policy is necessary is stored in the memory 202 or on the storage device 211.

In the case that access environment change policy is not applied, by stepping to “no”, access right corresponding to current location and type of the operating terminal 103 or 104 and to current location of the operated terminal 102 is applied (S4080). In other words, the access right determination processing unit 221 acquires access right corresponding to the access environmental information acquired at S4000, S4020, and S4030 from the access right table 231, and the access right is notified to the access control processing units 324 of the operated terminal 102 and of the operating terminal (rich client) 103.

On the other hand, in the case that access environment change policy is applied, next step is “yes”. The access right determination processing unit 221 compares information related to access environments respectively received at S4000, S4020, and S4030 with the access environment change policy table 232, and thereby determines whether or not corresponding records are contained in the access environment change policy table 232 (S4050).

If corresponding records are contained in the access environment change policy table 232, the access right determination processing unit 221 steps to “yes”, and requests the operating terminal (rich client) 103 for execution of software distribution/startup process (S4060) in order to change access environments of the operating terminal (rich client) 103 accessing resources.

The software distribution/startup process is executed by transmitting a software distribution/startup request, program name defined in the countermeasure policy 805, and a terminal ID received at S4000 to the operating terminal (rich client) 103 accessing resources.

The access right determination processing unit 221 acquires an execution result of the software distribution/startup process from the operating terminal (rich client) 103, and determines whether or not the software distribution/startup process is executed with success (S4070).

If the execution of software distribution/startup process is successful, the access right determination processing unit 221 re-executes steps from S4000 in order to determine access right for resources under changed access environments.

On the other hand, if the execution of software distribution/startup process is unsuccessful, the access right determination processing unit 221 acquires access right, that corresponds to information related to the access environments acquired at S4000, S4020, and S4030, from the access right table 231, and the access right is notified to the access control processing units 324 of the operated terminal 102 and the operating terminal (rich client) 103 (S4080).

If corresponding records are not contained in the access environment change policy table 232 at S4050, the access right determination processing unit 221 acquires access right, that corresponds to information related to access environments acquired at S4000, S4020, and S4030, from the access right table 231, and the access right is notified to the access control processing units 324 of the operated terminal 102 and the operating terminal (rich client) 103.

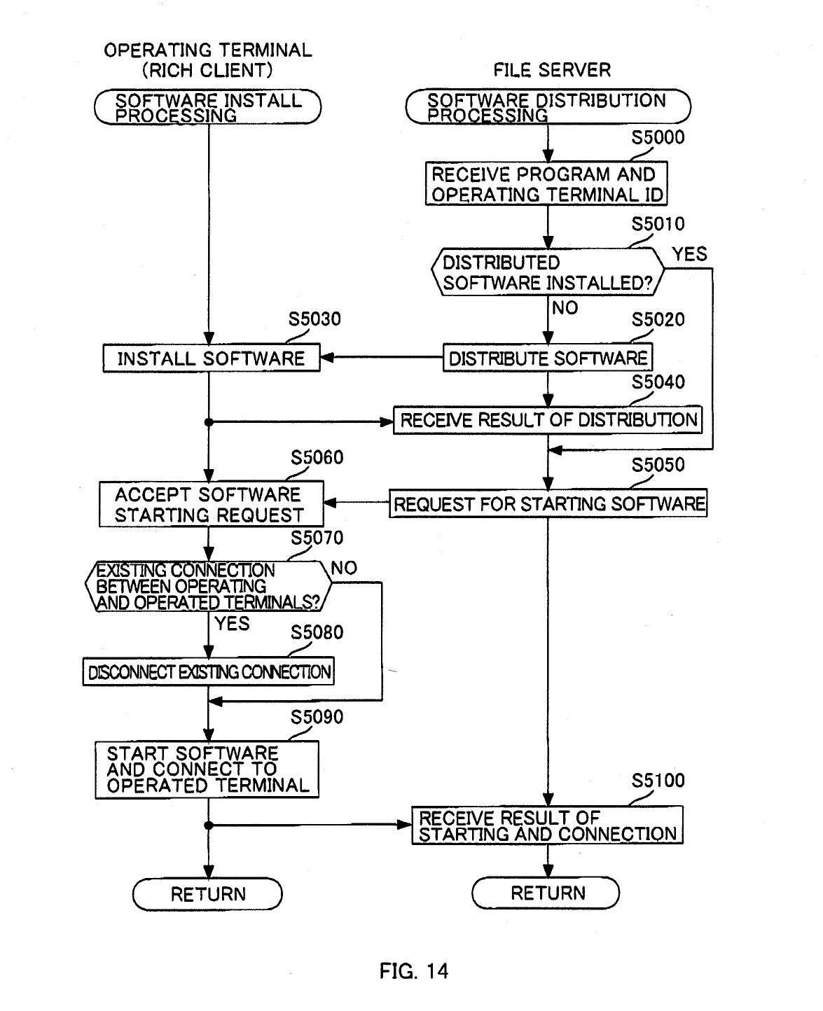

FIG. 14 is a flowchart of exemplary processes of the software distribution processing unit 323 of the file server 101 and the software installation processing unit 422 of the operating terminal (rich client) 103.

When the software distribution processing unit 323 of the file server 101 accepts a request for executing a software distribution/startup process, the software distribution processing unit 323 receives name of a program to be distributed from the access right determination processing unit 221 and a terminal ID of the operating terminal (rich client) 103 that is an object for distribution (S5000).

The software distribution processing unit 323 of the file server 101 determines whether or not the program requested at S5000 has already been installed (S5010) referring to, e.g., a registry in which information on software that is already installed in the operating terminal (rich client) 103 corresponding to the terminal ID received.

If the software has not been installed, the software distribution processing unit 323 of the file server 101 transmits an installer of the software to the operating terminal (rich client) 103 from the file server 101 (S5020).

When the software installation processing unit 422 of the operating terminal (rich client) 103 receives the installer, the software installation processing unit 422 of the operating terminal (rich client) 103 executes an installation process (S5030).

The software installation processing unit 422 of the operating terminal (rich client) 103 notifies the file server 101 of an execution result of software distribution and installation processes.

The file server 101 determines an execution result of software distribution and installation processes by receiving results of software distribution and installation (S5040).

On the other hand, if it is found by the result of S5010 that the software has already been installed, the software distribution processing unit 323 of the file server 101 does not execute software distribution and installation processes.

Thus when the operating terminal (rich client) 103 is installed with new software, the software distribution processing unit 323 of the file server 101 transmits a request for starting the software to the operating terminal (rich client) 103 (S5050).

When the operating terminal (rich client) 103 receives the request for starting the software (S5060), the operating terminal (rich client) 103 checks an established connection to the operated terminal 102 (S5070).

If there is an established connection, the operating terminal (rich client) 103 once ends the established connection by breaking the connection to the operated terminal 102 (S5080).

If there is not any established connection, the operating terminal (rich client) 103 does not execute a process for breaking an established connection.

When all connections between the operated terminal 102 and the operating terminal (rich client) 103 are broken, the operating terminal (rich client) 103 executes starting process of the software received from the file server 101, and makes a remote connection to the operated terminal 102, establishing a new connection to the operated terminal 102 (S5090).

The operating terminal (rich client) 103 notifies the file server 101 of an execution result of a software starting/connection process, and the file server 101 receives a result of software starting/connection (S5100), completing a changing process of access environments for resources.

An embodiment was explained above in detail. According to this embodiment, access right for resources on the network 600 is determined based on location and type of the operating terminal 103 or 104 and on location of the operated terminal 102 acquired from the operating terminal 103 or 104 and the operated terminal 102, respectively, by controlling access right assigned corresponding to operational environments of the operating terminal 103 or 104 such as location and type and to an operational environment of the operated terminal 102 such as location.

When the operated terminal 102 receives a request for remote connection from the operating terminal 103 or 104 during monitoring a request for remote connection from the operating terminal 103 or 104, access right for a resource that is currently accessed by the operated terminal 102 is re-determined so that the access right for the resource is appropriately maintained.

A means described above ensures access control for resources corresponding to operational environments of the operating terminal 103 or 104 such as location and type and to an operational environment of the operated terminal 102 such as location.

Change of access environments for resources may be done by providing a means that automatically installs software necessary for a remote connection or recommended software for a remote connection to the operating terminal 103 or 104 by determining a need for changing access environments for resources based on location and type of the operating terminal 103 or 104 and on location of the operated terminal 102 and a means that automatically remote-connects the operating terminal 103 or 104 to the operated terminal 102.

This ensures access control appropriate for a security level of a terminal such as location and type of a terminal that intends to access resources on the network 600.

Thus a thin client terminal that does not have a writable hard disc drive, therefore, containing low risk of information leakage is permitted to refer and edit in-company resources from the outside environment, while a rich client terminal that has a writable hard disc drive, therefore, containing high risk of information leakage is forbidden to refer and edit in-company resources from the outside environment. This ensures improvement of convenience as minimizing risk of information leakage.

Since environments of a terminal that intends to access resources on the network 600 may be changed, environments having low risk of information leakage may be automatically created, thus achieving the improvement of security and convenience and reduction of operation load of users and an administrator.

What is claimed is:

1. An information processing system comprising:
a service using terminal that accepts an operation input;
a service providing server that provides a service of receiving data, that is input to the service using terminal, from the service using terminal, executing information processing in response to the input data, and transmitting a result of the execution to the service using terminal; and
a data server that stores data, the service using terminal, the service providing server, and the data server being communicably connected to one another,
the service using terminal including
a data-input/output request transmitting unit that transmits a data-input/output request to the service providing server for data-input to or data-output from the data server, an operational environment acquiring unit that acquires information indicative of operational environments of the service using terminal, and
an operational environment transmitting unit that transmits the acquired information indicative of operational environments to the service providing server,
the service providing server including
a data-input/output request receiving unit that receives the data-input/output request and the information indicative of operational environments from the service using terminal, and
an I/o request transmitting unit that transmits the data-input/output request and the information indicative of operational environments to the data server,
the data server including
a data storing unit that stores data,
an I/O request receiving unit that receives the data-input/output request and the information indicative of operational environments from the service providing server,
data input/output control information that links operational environments of the service using terminal and information indicative of permission/disallowance to input data to or to output data from the data storing unit,
a data input/output permission determining unit that determines permission or disallowance to input data to or to output data from the data storing unit by referring to the data input/output control information and based on the received information indicative of operational environments, and
a data input/output processing unit that executes a process to input data to or to output data from the data storing unit in response to a result of the determination.

2. The information processing system of claim 1, wherein
the information indicative of operational environments, that is acquired by the operational environment acquiring unit of the service using terminal, is information indicative of current location of the service using terminal.

3. The information processing system of claim 2, wherein
the operational environment acquiring unit includes a GPS (Global Positioning System) receiver, and wherein
the information indicative of operational environments includes information indicative of latitude and longitude that designates a current location of the service using terminal.

4. The information processing system of claim 1, wherein
the information indicative of operational environments acquired by the operational environment acquiring unit is information indicative of whether or not the service using terminal has a data writable non-volatile storage device.

5. The information processing system of claim 1, wherein
a plurality of the service using terminals are communicably connected to the service providing server, wherein
the data server includes
a read-out data transmitting unit that, if the data-input/output request received from the service providing server is a data readout request, transmits data that is read out from the data storing unit to the service providing server in response to the data readout request, wherein
the service providing server includes
a data receiving unit that receives the data that is read out from the data server in response to the data readout request,
a display information generating unit that generates display information indicative of the received data, and
a display data transmitting unit that transmits the generated display information to each of the plurality of service using terminals, wherein
the data input/output permission determining unit of the data server determines whether or not to permit to read out from the data storing unit by comparing respective information indicative of operational environments of the plurality of service using terminals with the data input/output control information, and wherein
the data input/output processing unit of the data server does not execute the readout of data from the data storing unit if at least one result of the determination gives disallowance to read out the data.

6. The information processing system of claim 1, wherein
the service providing server includes a second operational environment acquiring unit that acquires information indicative of operational environments of the service providing server, wherein
the I/O request transmitting unit of the service providing server transmits to the data server a data-input/output request received from the service using terminal, information indicative of operational environments of the service using terminal, and information indicative of an operational environment of the service providing server, wherein
the I/O request receiving unit of the data server receives from the service providing server the data-input/output request, information indicative of operational environments of the service using terminal, and information indicative of an operational environment of the service providing server, wherein
the data input/output control information of the data server links respective operational environments of the service using terminal and the service providing server with information indicative of permission or disallowance to input/output of the data, and wherein
the data input/output permission determining unit of the data server determines whether or not to permit data input/output referring to the data input/output control information and based on information indicative of respective operational environments of the service using terminal and the service providing server.

7. The information processing system of claim 1, wherein
the service using terminal includes
a program executing unit that executes a service using program for receiving the service provided by the service providing server,
a program information transmitting unit that transmits identification information of the service using program, that is being executed, to the service providing server,
a recommended program receiving unit that receives from the data server a new service using program recommended for receiving the service, and
a program updating unit that updates a service using program being executed by the program executing unit to the new service using program received, wherein
the data-input/output request receiving unit of the service providing server receives from the service using terminal the data-input/output request, the information indicative of operational environments, and identification information of the service using program being executed, wherein
the I/O request transmitting unit of the service providing server transmits to the data server the data-input/output request, the information indicative of operational environments, and identification information of the service using program being executed, wherein
the I/O request receiving unit of the data server receives from the service providing server the data-input/output request, the information indicative of operational environments, and identification information of the service using program being executed, and wherein
the data server includes
a recommended program storing unit that stores a service using program recommended for receiving the service provided by the service providing server and
a recommended program transmitting unit that transmits to the service using terminal the service using program, that is stored in the recommended program storing unit, as the new service using program in response to identification information of the service using program, that is being executed by the service using terminal, received by the I/O request receiving unit.

8. A control method for an information processing system having a service using terminal that accepts an operation input, a service providing server that provides a service by receiving data, that is input to the service using terminal, from the service using terminal, executing information processing in response to the input data, and transmitting a result of the execution to the service using terminal, and a data server that stores data, the service using terminal, the service providing server, and the data server being communicably connected to one another, the control method comprising:
the service using terminal transmitting a data-input/output request for input data to or output data from the data server to the service providing server,
the service using terminal acquiring information indicative of operational environments of the service using terminal, and
the service using terminal transmitting the acquired information indicative of operational environments to the service providing server;
the service providing server receiving the data-input/output request and the information indicative of operational environments from the service using terminal, and
the service providing server transmitting the data-input/output request and the information indicative of operational environments to the data server; and
the data server receiving the data-input/output request and the information indicative of operational environments from the service providing server,
the data server storing data input/output control information that links operational environments of the service using terminal with information indicative of permission or disallowance to input data to or to output data from the data server,
the data server determining permission or disallowance to input data to or output data from the data server based on the received information indicative of operational environments and the data input/output control information, and
the data server executing a process to input data to or to output data from the data server in response to a result of the determination.

9. The control method for an information processing system of claim B, wherein
the information indicative of operational environments acquired by the service using terminal of the information processing system is information indicative of current location of the service using terminal.

10. The control method for an information processing system of claim 9, wherein
the service using terminal of the information processing system includes a GPS (Global Positioning System) receiver and wherein
the information indicative of operational environments includes information indicative of latitude and longitude that designates a current location of the service using terminal.

11. The control method for an information processing system of claim 8, wherein
the information indicative of operational environments acquired by the service using terminal is information indicative of whether or not the service using terminal has a data writable non-volatile storage device.

12. The control method for an information processing system of claim 8, further comprising:
the data server, if the data-input/output request received from the service providing server is a data readout request, transmitting data that is read out from the data server in response to the data readout request to the service providing server;
the service providing server receiving the data that is read out from the data server in response to the data readout request from the data server,
the service providing server generating display information indicative of the data received, and
the service providing server transmitting the generated display information to each of a plurality of the service using terminals; and
the data server determining whether or not to permit to read out data from the data server based on information indicative of operational environments of the plurality of service using terminals and the data input/output control information, and
the data server not executing the readout of data from the data server if at least one result of the determination gives disallowance to read out the data.

13. The control method for an information processing system of claim 8, further comprising:
the service providing server acquiring information indicative of an operational environment of the service providing server, and
the service providing server transmitting to the data server a data-input/output request received from the service using terminal, information indicative of operational environments of the service using terminal, and information indicative of an operational environment of the service providing server;
the data server receiving from the service providing server the data-input/output request, information indicative of operational environments of the service using terminal, and information indicative of an operational environment of the service providing server;
keeping in the data input/output control information information that links respective operational environments of the service using terminal and the service providing server with information indicative of permission or disallowance to input data to or to output data from the data server; and
the data server determining permission or disallowance of data input/output based on information indicative of operational environments of the service using terminal and the service providing server and on the data input/output control information.

14. The control method for an information processing system of claim 8, further comprising:
the service using terminal executing a service using program for receiving the service provided by the service providing server, and
the service using terminal transmitting identification information of the service using program, that is being executed, to the service providing server;
the service providing server receiving from the service using terminal the data-input/output request, the information indicative of operational environments, and the identification information of the service using program, that is being executed, and
the service providing server transmitting to the data server the data-input/output request, the information indicative of operational environments, and the identification information of the service using program, that is being executed;
the data server receiving from the service providing server the data-input/output request, the information indicative of operational environments, and the identification information of the service using program, that is being executed,
the data server storing a service using program recommended to receive the service provided by the service providing server, and
the data server transmitting to the service using terminal the recommended service using program as a new service using program in response to the received identification information of the service using program, that is being executed by the service using terminal; and
the service using terminal receiving from the data server a new service using program recommended to receive the service, and
the service using terminal updating the service using program, that is being executed, to the new service using program received.

15. A computer program operable to cause an information processing system having a service using terminal that accepts an operation input, a service providing server that provides a service by receiving data, that is input to the service using terminal, from the service using terminal, executing information processing in response to the input data, and transmitting a result of the execution to the service using terminal, and a data server that stores data, the service using terminal, the service providing server, and the data server being communicably connected to one another to perform:
the service using terminal transmitting a data-input/output request for input data to or output data from the data server to the service providing server,
the service using terminal acquiring information indicative of operational environments of the service using terminal, and
the service using terminal transmitting the acquired information indicative of operational environments to the service providing server;
the service providing server receiving the data-input/output request and the information indicative of operational environments from the service using terminal, and
the service providing server transmitting the data-input/output request and the information indicative of operational environments to the data server; and
the data server receiving the data-input/output request and the information indicative of operational environments from the service providing server,
the data server storing data input/output control information that links operational environments of the service using terminal with information indicative of permission or disallowance to input data to or to output data from the data server,
the data server determining permission or disallowance to input data to or output data from the data server based on the received information indicative of operational environments and the data input/output control information, and
the data server executing a process to input data to or to output data from the data server in response to an result of the determination.
